(19) United States
(12) Patent Application Publication
(10) Pub. No.: US 2022/0281065 A1
(43) Pub. Date: Sep. 8, 2022

(54) A PEENING DEVICE AND METHOD

(71) Applicant: NELSON MANDELA UNIVERSITY, Summerstrand, Port Elizabeth (ZA)

(72) Inventors: Stephen Grewar, Summerstrand, Port Elizabeth (ZA); Ian Norman Wedderburn, Summerstrand, Port Elizabeth (ZA)

(21) Appl. No.: 17/637,399

(22) PCT Filed: Aug. 20, 2020
(86) PCT No.: PCT/IB2020/057832

§ 371 Date: Feb. 22, 2022

(30) Foreign Application Priority Data
Aug. 22, 2019 (ZA) 2019/05529

(51) Int. Cl. B24B 39/02; B24B 39/00

(52) U.S. Cl. CPC B24B 39/026; B24B 39/006

(57) ABSTRACT

A device and method are provided for peening a surface. The peening device comprises a rotatable member, a flexible line that extends from the rotatable member and a peening element that is provided on the flexible line. In use, the line and peening element are rotated about the rotatable member such that when the peening element comes into contact with the surface, the surface is peened as result of kinetic energy of the peening element.

### CROSS-REFERENCE TO RELATED APPLICATION

This application claims priority from South African provisional patent application number 2019/05529 which is incorporated by reference herein.

### FIELD OF THE INVENTION

This invention relates to a device and method for peening a surface.

### BACKGROUND TO THE INVENTION

Peening relates to the process of treating the surface of an object, generally a metal surface, with the view of improving its material properties. Peening induces residual compressive stress in a surface due to plastic deformation. As cracks typically do not grow in a compressive environment, these surface compressive stresses provide resistance to metal fatigue and certain forms of corrosion. Peening may also harden the surface of the metal which reduces the likelihood of abrasions and cracks forming.

Peening is usually achieved by mechanical methods that expand the surface of the metal to induce compressive stresses. Well known peening methods include shot peening, hammer blows, ultrasonic peening and laser peening. A number of different devices for peening a surface exist.

U.S. Pat. No. 3,638,464 discloses a rotary wheel in which spheroidal peening particles are affixed to flaps that extend radially from the wheel. The peening particles are bonded to the fibers of the flaps by an organic adhesive.

U.S. Pat. No. 3,834,200 also discloses a similar flap construction comprising a strap with a support base mechanically fastened to it with peening particles metallurgically joined to an exposed face of the support base. The support base is formed from a metal.

These prior art devices have various shortcomings. They are not easily adapted to accommodate different peening requirements and they are limited in their ability to operate in confined spaces. Many regions in mechanical equipment that require peening may be hard to reach using conventional peening devices and methods. Moreover, known peening devices are complex in their design which may make them more expensive to manufacture, maintain and replace. The present invention aims to address these shortcomings, at least to some extent.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

According to an aspect of the present invention there is provided a peening device comprising:
a rotatable member;
a flexible line that extends from the rotatable member; and
a peening element that is provided on the flexible line, wherein the flexible line and peening element are operatively rotatable about the rotatable member to peen a surface in use.

The rotatable member may be a spindle, a pin, a rod, a shaft, a bolt, a hub, a core, or any structure which is operatively rotatable about an axis.

The peening element may be operatively located at a part of the flexible line furthest away from the spindle or rotatable member. The flexible line may have a plurality of peening elements provided thereon. The peening element may be formed from a hard or tough material selected from the group consisting of: tungsten, titanium, steel, glass, composite materials and various ceramics.

The plurality of peening elements may be arranged in a cluster.

The flexible line may be arranged in a loop with one or more peening elements through the loop. The flexible line may be clamped to the rotatable member or spindle. A clamp may be provided to clamp the flexible line to the rotatable member or spindle.

The flexible line may be a single strand extending from the rotatable member. One or more peening elements may be attached to the flexible line or to the single strand. One or more peening elements may be attached at or near an end of the flexible line or at or near an end of the single strand. The end of the flexible line or single strand where the one or more peening elements are attached may be remote from the rotatable member. A plurality of strands or flexible lines may also be used, each having one or more peening elements thereon. The plurality of flexible lines may extend radially relative to the rotatable member during rotation.

The spindle or rotatable member may include a proximal end and a distal end. The spindle or rotatable member may be elongate and the spindle or rotatable member may extend along a major axis and may be rotatable thereabout. The flexible line may extend transversely relative to the major axis of the spindle or rotatable member, in use. The proximal end may be configured to be attached to a rotary drive for rotating the spindle or rotatable member in use, with the flexible line extending from the distal end of the spindle or rotatable member.

The spindle or rotatable member may be operatively rotatable about its major axis so as to cause the flexible line to extend and the peening element to move in a generally circular path around the major axis of the spindle or rotatable member in use. The flexible line may extend radially relative to the spindle or rotatable member during rotation.

The spindle may be a shaft. The proximal end of the spindle may include a shoulder for facilitating attachment to the rotary drive. The shoulder may abut with a mounting arrangement of the rotary drive.

The peening element may have an aperture therethrough. The peening element may be a bead, or it may be shaped like a bead. The bead may include an aperture therethrough. The flexible line may be threaded through the aperture of the bead or peening element. In the case of the flexible line being arranged in a loop, the flexible line may be threaded through the bead before being arranged to form the loop. The flexible line may include a first end and a second end. The first end of the flexible line and the second end of the flexible line may be clamped to the distal end of the spindle or rotatable member to form the loop. The first and second end of the flexible line may be threaded through the bead.

In the case of the flexible line being a single strand, a first end of the flexible line may be clamped or fastened to the distal end of the rotatable member with the flexible line threaded through the bead or through the peening element. A second end, a free end, or an unclamped end of the flexible line or single strand may be arranged to secure one or more peening elements thereat.

In the case of a plurality of beads being used, one or more of the beads may have one of the first and second ends of the flexible line threaded therethrough, with one or more of the beads having both of the first and second ends of the flexible line threaded therethrough. The one or more beads with both of the first and second ends of the flexible line threaded therethrough may be arranged to form the remainder of the beads into a cluster of beads.

The flexible line and peening element may be arranged to be rotated about the major axis of the spindle or rotatable member at an angular velocity such that when the peening element operatively comes into contact with the surface, the surface may be peened as result of kinetic energy of the peening element.

When in use, rotation of the spindle may cause the flexible line to extend as result of a centrifugal force associated with the peening element and/or as result of a centrifugal force associated with the flexible line. The flexible line may perform a whipping action when the spindle is rotated about its major axis.

According to another aspect of the present invention there is provided a method of peening a surface, the method comprising:
providing a peening device, the peening device having a rotatable member with a flexible line that extends from the rotatable member and a peening element that is provided on the flexible line; and
rotating the peening device such that when the peening element operatively comes into contact with the surface, the surface is peened.

The rotatable member may be a spindle, a pin, a rod, a shaft, a bolt, a hub, a core, or any structure which is operatively rotatable about an axis.

The method may include rotating the peening device such that the flexible line extends transversely relative to a major axis of the spindle or rotatable member, and such that the peening element rotates at an angular velocity relative to the major axis to operatively peen the surface. The surface may be operatively peened as result of kinetic energy of the peening element when it comes into contact with the surface.

The method may include implementing the flexible line in a loop with one or more peening elements through the loop.

The method may include implementing the flexible line as a single strand extending from the rotatable member.

The method may include providing one or more peening elements at or near an end of the flexible line, or at or near an end of the single strand.

Embodiments of the invention will now be described, by way of example only, with reference to the accompanying drawings.

### BRIEF DESCRIPTION OF THE DRAWINGS

In the drawings:

FIG. 1 is a three-dimensional view of an example embodiment of a peening device with one peening bead;

FIG. 2 is a top view of the peening device of FIG. 1;

FIG. 3 is a three-dimensional view of the peening device in FIG. 1 with two peening beads;

FIG. 4 is a top view of the peening device of FIG. 3;

FIG. 5 is a three-dimensional view of the peening device of FIG. 1 with three peening beads;

FIG. 6 is a top view of the peening device of FIG. 5;

FIG. 7 is a three-dimensional view of another example embodiment of the peening device;

FIG. 8 is a top view of the peening device of FIG. 7;

FIG. 9 is a three-dimensional view of yet another example embodiment of the peening device;

FIG. 10 is a diagram showing exemplary control parameters that may be used for testing, or for configuring the peening device for use;

FIG. 11 is a photograph of a section of an exemplary test coupon after testing various peening parameters;

FIG. 12A is another photograph of the exemplary test coupon showing the visual appearance of an exemplary effect of peening in a 0.5 mm deep groove;

FIG. 12B is a photograph of an enlarged section of the test coupon in FIG. 12A;

FIG. 12C is a photograph of another enlarged section of the test coupon in FIG. 12A;

FIG. 13A is another photograph showing the visual appearance of the effect of peening in a 3 mm deep groove;

FIG. 13B is a photograph of an enlarged section of the test coupon in FIG. 13A; and

FIG. 14 is a flow diagram of an exemplary method of peening a surface.

### DETAILED DESCRIPTION WITH REFERENCE TO THE DRAWINGS

According to an aspect of the present invention there is provided a peening device including a rotatable member, a flexible line that extends from the rotatable member and a peening element that is provided on the flexible line. The flexible line and peening element are operatively rotatable about the rotatable member to peen a surface in use.

The rotatable member may be a spindle, a pin, a rod, a shaft, a bolt, a hub, a core, or any structure which is operatively rotatable about an axis. The rotatable member may be elongate and may extend along a major axis so as to be rotatable thereabout. The flexible line may extend transversely relative to the major axis of the rotatable member, in use.

The rotatable member may be operatively rotatable about its major axis so as to cause the flexible line to extend and the peening element to move in a generally circular path around the major axis of the rotatable member. During rotation, the flexible line may extend radially relative to the rotatable member.

The rotatable member may include a proximal end and a distal end. The proximal end of the rotatable member may be configured or adapted to be attached or fitted to a rotary drive for rotating the rotatable member in use, with the flexible line extending from the distal end of the rotatable member. The proximal end may include a shoulder for facilitating attachment to the rotary drive. The shoulder may abut with a mounting arrangement of the rotary drive.

The flexible line and peening element may be arranged to be rotated about the major axis of the rotatable member at an angular velocity such that when the peening element operatively comes into contact with the surface, the surface may be peened as result of kinetic energy of the peening element. When in use, rotation of the rotatable member may cause the flexible line to extend as result of a centrifugal force associated with the peening element and/or as result of a centrifugal force associated with the flexible line. The flexible line may perform a whipping action when the rotatable member is rotated about its major axis.

The peening element may be formed from a hard or tough material selected from the group consisting of: tungsten, titanium, steel, glass, composite materials and various ceramics. The material may be configured to have a hardened outer surface to withstand the peening conditions it will be subjected to. The peening element may be any suitable size and shape. The peening element may be operatively located at a part of the flexible line furthest away from the rotatable member. The flexible line may have a plurality of peening elements provided thereon and a plurality of peening elements may be arranged in a cluster.

The flexible line may be arranged in a loop with one or more peening elements through the loop. The flexible line may be clamped to the rotatable member or spindle. A clamp may be provided to clamp the flexible line to the rotatable member or spindle. The flexible line may alternatively be a single strand extending from the rotatable member. One or more peening elements may be attached to the flexible line or to the single strand. One or more peening elements may be attached at or near an end of the flexible line or at or near an end of the single strand. The end of the flexible line or single strand where the one or more peening elements are attached may be remote from the rotatable member. A plurality of strands or flexible lines may also be used, each having one or more peening elements thereon. The plurality of flexible lines may extend radially relative to the rotatable member during rotation.

The peening element may have an aperture therethrough. The peening element may be a bead, or it may be shaped like a bead. The bead may include an aperture therethrough. The flexible line may be threaded through the aperture of the bead or peening element. In the case of the flexible line being arranged in a loop, the flexible line may be threaded through the bead before being arranged to form the loop. The flexible line may include a first end and a second end. The first end of the flexible line and the second end of the flexible line may be clamped to the distal end of the rotatable member to form the loop. The first and second end of the flexible line may be threaded through the bead.

In the case of the flexible line being a single strand, a first end of the flexible line may be clamped or fastened to the distal end of the rotatable member with the flexible line threaded through the bead or through the peening element. A second end, a free end, or an unclamped end of the flexible line or single strand may be arranged to secure one or more peening elements thereat.

In the case of a plurality of beads being used, one or more of the beads may have one of the first and second ends of the flexible line threaded therethrough, with one or more of the beads having both of the first and second ends of the flexible line threaded therethrough. The one or more beads with both of the first and second ends of the flexible line threaded therethrough may be arranged to form the remainder of the beads into a cluster of beads.

According to another aspect of the present invention there is provided a method of peening a surface, the method including providing a peening device, the peening device having a rotatable member with a flexible line that extends from the rotatable member and a peening element that is provided on the flexible line; and rotating the peening device such that when the peening element operatively comes into contact with the surface, the surface is peened.

The method may include rotating the peening device such that the flexible line extends transversely relative to a major axis of the spindle or rotatable member, and such that the peening element rotates at an angular velocity relative to the major axis to operatively peen the surface. The surface may be operatively peened as result of kinetic energy of the peening element when it comes into contact with the surface.

The method may include implementing the flexible line in a loop with one or more peening elements through the loop, or alternatively, implementing the flexible line as a single strand extending from the rotatable member. The method may include providing one or more peening elements at or near an end of the flexible line, or at or near an end of the single strand.

During use, the peening element may travel in a substantially planar and generally circular motion due to the centrifugal reaction force of its mass and centripetal acceleration creating a whipping action. This peening method may be referred to as “whip peening”.

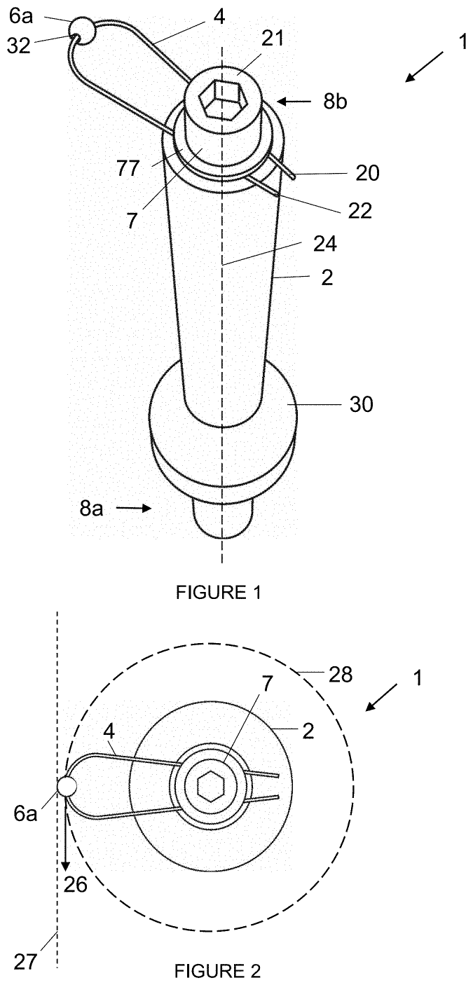

FIGS. 1 to 9 show different embodiments of the peening device. The peening device may be configured to be mounted on a rotary drive and used to treat surfaces, generally metal surfaces, by repeatedly striking the surface as the peening device rotates. The peening device may be referred to as a striking device and it may include an elongate body or rotatable member having a central axis or major axis. A striking element may be attached to a flexible member which may be attached to the elongate body to extend therefrom. The flexible member may be rotated about the elongate body of the peening device, so that the striking element revolves about the central axis or major axis. When the striking element impacts the surface, the surface may be peened or treated. Other surfaces such as composite surfaces or non-metallic surfaces may also be treated or peened with the peening device. The peening device may also be referred to as a whip-peening device.

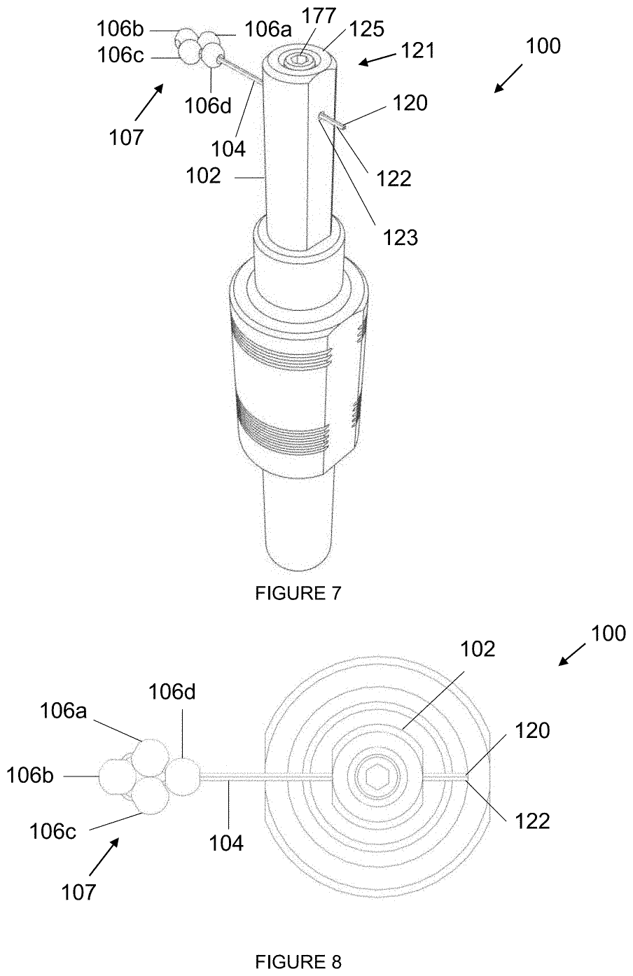

FIGS. 1 and 2 show an example embodiment of the peening device (1). A rotatable member such as a spindle (2) is provided that is configured to receive a flexible line (4). The line (4) has a peening element, in this case a bead (6a), provided thereon. The spindle (2) has a proximal end (8a) and a distal end (8b), with the proximal end (8a) configured to be mounted on a rotary drive (not shown). The distal end (8b) may be configured to receive the line (4). In the present embodiment, a bolt (7) is provided to secure the line (4) to the spindle (2) at its distal end (8b). The bolt (7) may include a flange (77) to secure the line (4) to the distal end (8b) of the spindle (2) acting as a clamp. A first end (20) and a second end (22) of the line (4) may be clamped to the distal end (8b) of the spindle (2) by compressing the line (4) between the distal end (8b) and a head (21) of the bolt (7). Any other suitable fastener, adhesive, clip or clamp may also be used to secure or to attach the line to the distal end of the rotatable member or spindle (an example of which is shown in FIG. 7 and described below).

In the present embodiment, the rotatable member or spindle (2) is elongate and rod-shaped and extends along a major axis (24). The proximal end (8a) of the spindle (2) may include a shoulder (30) for facilitating attachment to the rotary drive. In use, the spindle (2) may be rotated about its major axis (24), so that the line (4) extends transversely relative to the major axis (24) as is evident from FIG. 2. The bead (6a) may be rotated about the spindle (2) to peen a surface in use. The bead (6a) may be rotated at an angular velocity relative to the major axis (24), as is diagrammatically illustrated by the directional arrow (26) in FIG. 2. Each time that the bead (6a) comes into contact with a surface to be peened may be referred to as a sweeping motion. The peening device (1) may be configured to peen a surface (27) by using the sweeping motion of the peening element. A number of sweeps may be performed on a surface during peening. The surface (27) is shown diagrammatically by broken lines in FIG. 2. It will be appreciated that the orientation of the surface (27) may be varied, depending on practical considerations. The surface may be flat, but curved or angled surfaces may also be peened by any of the exemplary peening devices disclosed herein.

The spindle (2) or rotatable member may operatively be rotated about its major axis (24), causing the flexible line (4) to extend, and the peening element (6a) may move in a generally circular path (28) around the major axis (24) of the spindle as is diagrammatically illustrated in FIG. 2. The line (4) may extend radially relative to the spindle (2) during rotation. In other words, the bead or peening device may, in use, spin or revolve around the spindle (2) travelling generally along the circular path (28) while peening the surface.

The bead (6a) may include an aperture (32) therethrough, and the line (4) may be threaded through the aperture (32) of the bead (6a). In the case of the line being arranged in a loop, the line may be threaded through the bead (or through a plurality of beads, as the case may be) before being arranged to form the loop. The bead (6a) or peening element may include a striking surface on its exterior for striking or hitting the surface (27) which is to be peened.

Embodiments are also possible wherein the flexible line may be a single strand or a single line extending from the rotatable member. The single strand may extend from the distal end of the rotatable member, and one or more peening elements may be attached at or near an end of the flexible line, or the one or more peening elements may be attached at or near an end of the single strand. The one or more peening elements may be provided anywhere on the flexible line. The single strand may be attached, or fastened, or clamped to the distal end of the rotatable member. Typically, the one or more peening elements may be provided at, or attached to an end of the single strand which is remote from the distal end of the rotatable member. In the case of the flexible line being a single strand, a first end of the flexible line may be clamped to the distal end of the rotatable member with the flexible line threaded through the bead. A second end, a free end, or an unclamped end of the flexible line may be arranged to secure one or more peening elements thereat. It will be appreciated that such an embodiment may include features of the other embodiments disclosed herein, and the other embodiments disclosed herein may include features of the embodiment with a single strand, or with one or more single strands extending from the rotatable member.

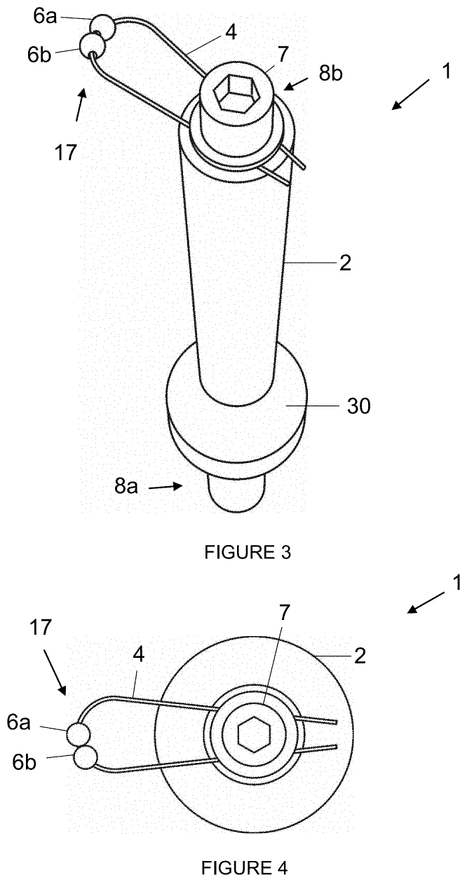

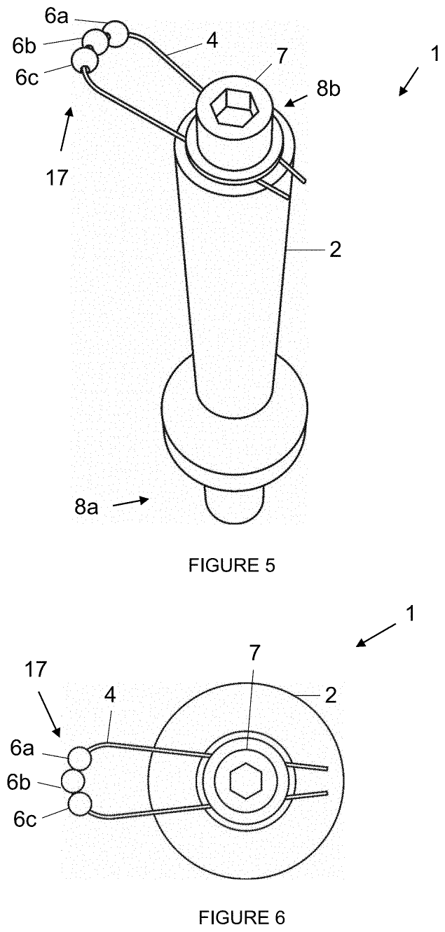

FIGS. 3 and 4 show the peening device (1) with two beads (6a, 6b) provided on the line (4) and FIGS. 5 and 6 show the peening device (1) with three beads (6a, 6b, 6c) provided on the line (4). The line (4) may be threaded through the beads (6a, 6b, 6c) and the beads (6a, 6b, 6c) may be moveable on the line (4). The plurality of peening elements or beads (6a, 6b, 6c) may be arranged in a cluster (17). The cluster (17) may include any number of peening elements, for example two peening elements (6a, 6b) in FIGS. 3 and 4, and three peening elements (6a, 6b, 6c) in FIGS. 5 and 6. The surface (27) shown in FIG. 2 is not shown in FIGS. 3 to 6, but it will be appreciated that a similar surface may be peened by the various embodiments of the present disclosure (including the embodiment of FIGS. 7-9 which is described in more detail below). As the one or more peening elements or cluster (17) of peening elements are rotated about the rotatable member (2), the peening element(s) may extend radially and may be swung or rotated around the major axis of the rotatable member (2). As result of centrifugal force, the cluster (17) of peening elements may tend to group together during rotation. This may be advantageous as the plurality of peening elements (6a, 6b, 6c) may impact the surface in succession, which may implement more efficient or more effective peening than known peening devices.

FIGS. 7 and 8 show another example embodiment of the peening device (100). In this example embodiment, a first end (120) of the flexible line (104) may be threaded through peening elements or beads, in this case three beads (106a, 106b, 106c), and the line (104) may be arranged in a loop formation. The first end (120) and a second end (122) of the line (104) may then be threaded through an additional or fourth bead (106d). The first and second end (120, 122) of the line (104) may be secured to a distal region (121) of the spindle (102), for example by threading these ends through an aperture (123) in the spindle (102) and tying a knot, or securing the line (104) to the spindle (102) in another way, such as clamping, clipping, fastening, using adhesives, etc. In the present embodiment, the ends (120, 122) of the line (104) may be clamped in the aperture (123) in the spindle (102), by securing a bolt (177) into the distal end (125) of the spindle (102). The fourth bead (106d) may limit the movement of the other beads (106a, 106b, 106c) on the line (104) and may restrict the width of a section of the loop formation. It will be appreciated that the embodiment of FIGS. 7 and 8 (or any of the disclosed embodiments) may also be implemented with a single strand used as flexible line extending from the rotatable member.

In the case of a plurality of beads (106a, 106b, 106c, 106d) being used, one or more of the beads (106a, 106b, 106c) may have one of the first and second ends (120, 122) of the flexible line threaded therethrough. One or more of the beads (in this case, fourth bead (106d)) may have both of the first and second ends (120, 122) of the flexible line threaded therethrough. The one or more beads (in this case, fourth bead (106d)) with both of the first and second ends of the flexible line threaded therethrough may be arranged to form, or to urge the remainder of the beads into a cluster of beads.

As seen in FIG. 8, the additional (fourth) bead (106d) may be arranged to move transversely away from a major axis of the spindle (102) during rotation of the spindle, such that the remainder of the beads (106a, 106b, 106c) are grouped or clustered together in use. This may cause the loop to tighten, and the other three beads (106a, 106b, 106c) may be grouped together as result of the fourth bead moving away from the major axis of the spindle during rotation. The plurality of peening elements or beads (106a, 106b, 106c, 106d) may hence be arranged in a cluster (107). Other means of forming the cluster may also be used, such as providing a plurality of further lines and attaching one or more beads to each of these further lines to form a bunch of lines with beads or peening elements. The bunch of lines with peening elements may be provided at a portion of the line that is remote from the spindle or remote from the rotatable member's major axis. The cluster (107) may provide the advantage that the peening elements are grouped together in use, so that they act collectively to peen the surface. One or more of the peening elements may impact the surface before one or more of the other peening elements impact the surface, or the cluster may impact the surface simultaneously at various points, which may result in the peening device covering or peening an extended area, as compared to a single peening element. This may provide advantages and more effective peening than with known peening devices or methods.

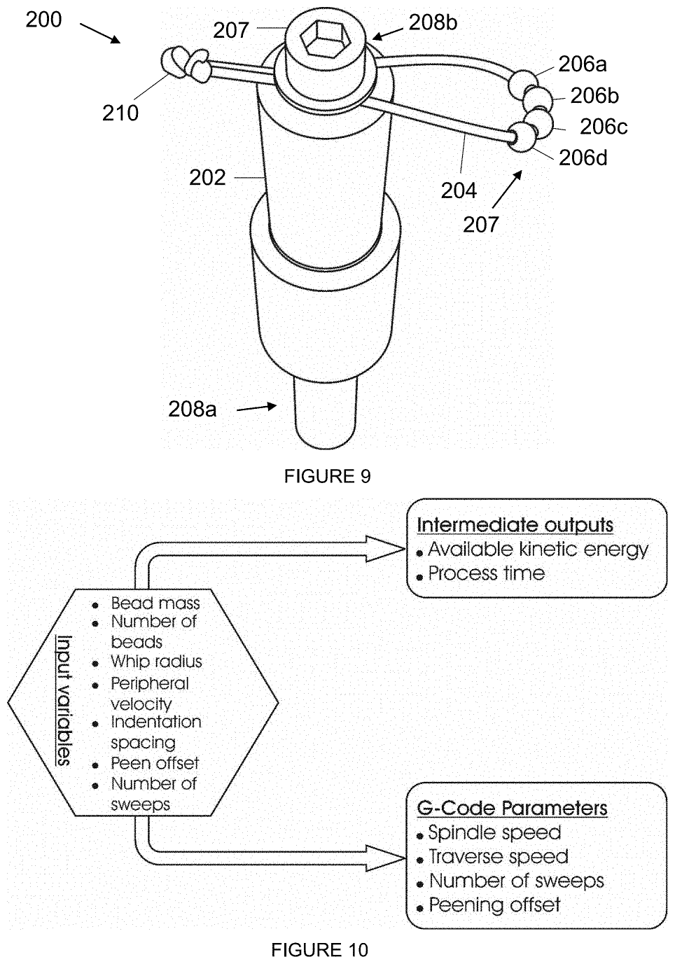

FIG. 9 shows yet another embodiment of the peening device (200) with a proximal (208a) and distal end (208b). The flexible line (204) has a knot (210) at the distal end (208b) of the spindle (202). The knot (210) may assist, in combination with the bolt (207), to secure or clamp the line (204) to the spindle (202). Four beads (206a, 206b, 206c and 206d) are provided on the line (204). Any suitable number of beads or peening elements may be provided on the line. The plurality of peening elements or beads (206a, 206b, 206c, 206d) may also be arranged in a cluster (207).

The line may be made from any suitable flexible material capable of withstanding the conditions of peening, for example Ultra-High Molecular Weight Polyethylene (UHMwPE) fibers or braids sold under the trade mark Dyneema®, nylon, steel cable, steel wire or a wide range of woven or unwoven materials. In some embodiments, the line may be a flexible chain which may be arranged to carry the one or more peening elements. A peening chain may be used, wherein the peeing elements may be the chain itself, or links in the chain. The line may also be made from a resilient material. The line may be secured to the spindle in a number of ways that ensures the line remains secured to the spindle when in use. The first and second ends of the line may be secured or fastened to the spindle so that the line forms a loop formation. A binding member may be provided on the loop formation to restrict the width of a section of the loop formation. The line may also be secured to the spindle at only one end thereof. More than one flexible line may be provided on the spindle or rotatable member and any suitable length of line may be used. In the case of a plurality of lines being used, a plurality of peening elements may be provided, with one or more peening elements being provided on each of the plurality of lines, so that the lines extend radially as the spindle is rotated in use. The plurality of lines may, during rotation, extend in a star-like formation (or similar to spokes of a wheel) from the major axis of the spindle. Each of the plurality of lines may be a single strand attached to the distal end of the rotatable member. Each of the lines may also have a plurality of peening elements, for example with a cluster of peening elements for each line at or near an end of the line remote from the distal end of the rotatable member.

The peening element may be formed or manufactured from any suitable tough, hard, strong, or fracture-resistant material, for example high strength tungsten, titanium, diamond, cast or forged steel, steel or iron based alloys, composites, ceramics, or other tough non-metallic elements etc. The hardness of the peening element should preferably be higher than the hardness of the surface to be peened and may therefore differ depending on the intended use. For example, the hardness of the peening element may range between 300 HV-800 HV (Vickers Hardness) or it may be 300 HV or greater, or 200 HV or greater, or about 300 HV, about 400 HV, about 500 HV, about 600 HV, about 700 HV or about 800 HV or more. The peening element may be of any suitable size and may be in the range of 0.5 mm to 5 mm or greater where the application calls for it. The peening element may have any suitable mass and the mass may range between 0.050 g to 1 g. However, it is envisaged that peening elements of a significantly larger scale (e.g. heavy peening elements of more than a gram each or even more than a kilogram) may also be possible. The peening element may be moveable on the line or may be fixed on the line and may have a generally circular shape. When in use, the peening element may be located at a part of the flexible line furthest away from the spindle. The peening element may have an aperture therethrough and the line may be threaded through the aperture to secure the peening element to the line.

In the embodiments shown in FIGS. 1 to 9, the peening element(s) are shaped as beads with apertures therethrough. However, it will be appreciated that many other shapes of peening element with corresponding aperture may be used such as, but not limited to, ball-shaped, spherical, oval, cylindrical, square, triangular, angled, or polyhedron shaped peening element(s). The aperture preferably extends through a body of the peening element, however the aperture may also be provided by a ring shaped formation or lug extending away from the body of the peening element so that the line may be threaded through the ring shaped formation or lug. In other words, each peening element may be shaped like a kettlebell. The peening element(s) themselves may also be ring shaped.

The spindle or rotatable member may have any suitable size and configuration. The proximal end of the spindle may be configured to be mounted on or fitted to a number of different types of rotary drives such as drills, mills, lathes or any machinery capable of rotating the spindle or rotatable member in use. This includes automated machines such as computer numerical control (CNC) machines. Typically, a chuck associated with the rotary drive may operatively hold or clamp the proximal end of the rotatable member or spindle as it rotates. The rotatable member may be shaped like a drill bit, so as to facilitate attachment or retrofitting the peening device to existing machinery or equipment. The distal end of the spindle may be configured to receive the line and may have a number of parts that fit together to assist in securing or clamping the line to the spindle or rotatable member. Alternatively, the line may be fastened to the spindle with an adhesive, or embodiments may be possible wherein the line is integrally formed with the spindle. An embodiment may also be possible wherein the spindle includes a hole through which the line is passed. A knot, or other blocking device may in such an embodiment inhibit the line from coming loose from the hole and the bead or peening device may be provided at an opposite end of the line. The spindle may be formed from any suitable material capable of withstanding the forces associated with the peening process. It will be appreciated that the spindle may be replaced by another rotatable member, for example a ball-shaped member or hub, or any other rotatable member or structure which is not necessarily elongated. The flexible line or plurality of flexible lines may extend from the rotatable member, with the peening element(s) provided thereon. Other types of rotatable members may include a pin, a rod, a shaft, a bolt, a hub, a core, or any structure which is operatively rotatable about an axis.

In use, the peening element is spun or rotated at a determined peripheral velocity to obtain a desired kinetic energy. The peening element is constrained in a spherical dimension about the rotational centre or spindle by means of the strong but flexible link or line allowing partial degrees of freedom to the rotating peening element. The peening element may travel in a substantially planar and generally circular motion due to the centrifugal reaction force of its mass and centripetal acceleration creating a whipping action. This peening method may be referred to as “whip peening”.

When the whipping peening element is brought into contact with a target surface the kinetic energy of the peening element is transferred to a local contact area on the surface resulting in a peening action.

With accurate position control (for example by implementing a CNC machine or other rotary drive which provides position control or computer implemented position control), machine parameters such as peening intensity and indentation spacing may be repeatedly achieved regardless of a whip radius or peening radius. The whip radius or peening radius may for example be defined as a radius measured from the major axis of the spindle (e.g. 2, 102, 202) to the peening element furthest away from the major axis, for example peening element (6a) in FIG. 1, or peening element (106b) in FIG. 7. Alternatively, the whip radius or peening radius may be a radius measured from the major axis to any one of the plurality of peening elements. The position of the peening device may be automatically controlled by the rotary drive, or machinery connected thereto. This includes positional control or predictive positional control of the peening elements being rotated at their respective radius or radiuses from the major axis.

Exemplary experiments or tests were conducted to test different parameters or control parameters of the peening device and the consequent outcomes of these experiments are described in more detail below. Parameters for the exemplary tests are illustrated in FIG. 10. Variable test parameters or control parameters may include: the number of beads or peening elements, indentation spacing, peripheral velocity, whip radius, available kinetic energy, peen contact offset and number of sweeps. Indentation spacing may be defined as a distance on the surface from one peening element impacting the surface, to the next peening element impacting the surface.

“Whip peening” in conjunction with a numerically controlled machine may lend itself to an automated and repeatable process. The peening intensity, observable by the indentation size and morphology, may be defined as a function of the available kinetic energy and the peening offset. The peening offset may be a depth of an indentation or groove where the peening element comes into contact with the surface. While the number of sweeps may have a minor role in peening effectiveness, peen offset appears to mainly influence peening effectiveness. For example, with lower sweeps and higher peen offset the effectiveness may be superior to lower peen offset with a higher number of sweeps.

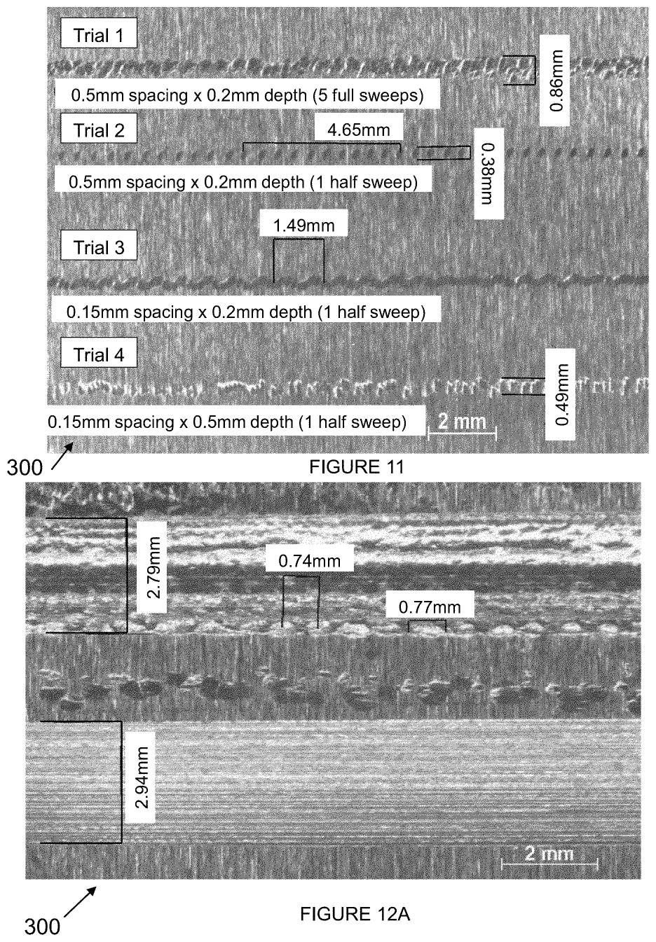

FIGS. 11 to 13 show a test coupon surface (300) that was subjected to the above described “whip peening” method. In FIG. 11 the following findings were observed:
1. Trial 1—Partial randomization of the peening effect may occur with multiple sweeps of a region. In other words, the peening elements do not necessarily impact the surface in a straight line. This may be advantageous as randomized impact locations may provide a more even distribution of peening.
2. Trial 2 and Trial 3—Even and consistent spacing may be achievable by input of the indentation spacing variable.
3. Trial 4—By increasing the peening offset from 0.2 mm (Trial 3) to 0.5 mm the indentation size increases, indicating that a greater percentage of the available kinetic energy is transferred to the coupon surface (300). As a secondary effect, by increasing the peening offset, the peening uniformity may be negatively affected.

In use, the major axis of the spindle or rotatable member of the peening device may be rotated generally parallel to the surface to be peened, or at an angle relative to the surface to be peened. Embodiments may be possible wherein the spindle may be moved in an axial direction during the peening operation, for example to increase a width of the area that is peened. The peening device may be moved in a peening direction (transversely to the major axis of the spindle), along a groove, as is evident from FIG. 11. When in use, the peening element's energy may be between 30 to 70 mJ and its velocity may be between 15-20 m/s. The indentation spacing may be between 0.15 to 0.5 mm or about 0.15 mm or about 0.5 mm. However, many other values may be possible, depending on the size of the peening element and the practical application.

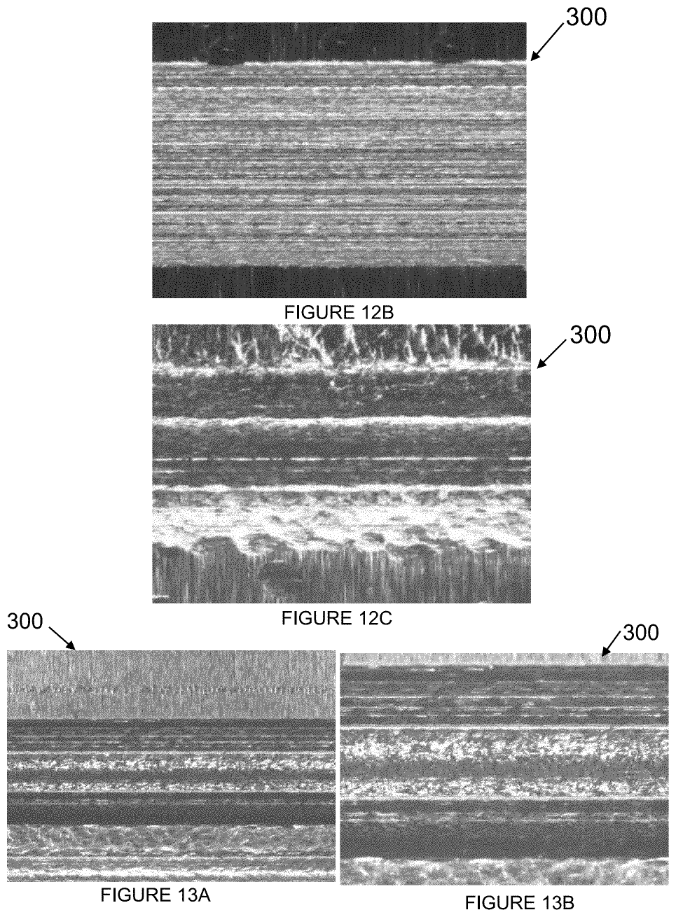

FIGS. 12A-C show a visual appearance of the effect of “whip peening” using an exemplary peening device (such as one of the peening devices in FIGS. 1 to 9 or a peening device according to the present disclosure) in a 0.5 mm deep groove ground into the test coupon surface (300). In the exemplary embodiment, peening may be performed to remove marks left by a grinding process that forms the groove. Due to the large degree of freedom associated with “whip peening”, good coverage may be achievable within the groove surface without requiring change of position in the axial direction of the peening device. After sufficient peening sweeps, little to no trace of the grinding marks may be observable.

Likewise, as shown in FIGS. 13A and 13B, in the case of a 3 mm deep groove, good peening coverage may be achieved without complex tool manipulation.

The present disclosure or “whip peening” approach may provide the following advantages over other devices or methods of peening:
1. The high degree of freedom generated by the peening element on the line may lead to good randomized coverage or randomized peening impact locations in confined spaces such as grooves and corner radii. This may allow the peening device to be used on objects that are normally difficult to peen such as castellated mechanical parts.
2. A high degree of process control may be afforded by the ‘whip peening” method of the present disclosure.
3. Peening media effectiveness may be influenced less by rebound phenomena as is the case with shot peening and bead blasting in confined spaces. This may at least partially be because of the peening elements of the present disclosure being attached to the flexible line.
4. Peening effectiveness may be developed in a laboratory environment and may be replicated in site applications by using proven process developed parameters.
5. The peening process may be generally clean, safe, and may be applied in-situ or directly at the required location. Therefore, there may be little to no need for additional work chambers, cleaning, or safety infrastructure.
6. The “whip peening” process may be performed rapidly and therefore potentially inexpensively.
7. A high level of control over the final surface condition may be achievable (for example indentation spacing and depth) which is generally not the case in most (if not all) other peening techniques.

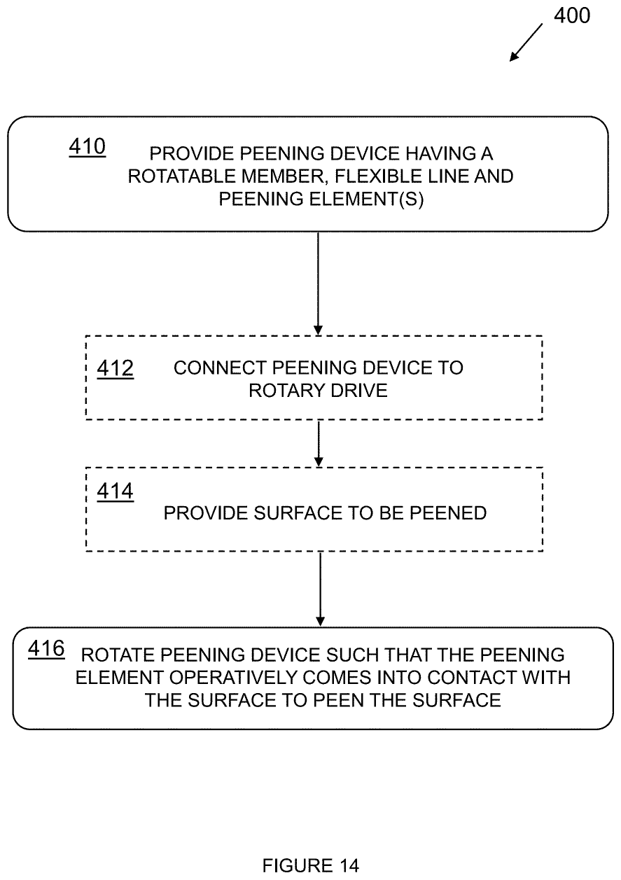

In FIG. 14 there is shown an exemplary method (400) of peening a surface. The method (400) may include providing (410) a peening device (for example one of the exemplary peening devices of FIGS. 1 to 9, or any of the embodiments of a peening device described herein), the peening device having a rotatable member with a flexible line that extends from the rotatable member and a peening element (or a plurality of peening elements) that is/are provided on the flexible line. The method may optionally include connecting (412) or attaching the peening device to a rotary drive such as a drill, mill or other rotating drive or mechanical or electrical rotating device for rotating the peening device. Control parameters may optionally be adjusted or implemented. The method may optionally also include providing (414) a surface to be peened, for example a metallic surface or any surface of a component, mechanical part, item or object that requires peening. The method (400) may further include rotating (416) the peening device such that the peening element operatively comes into contact with the surface, or impacts or engages the surface, to peen the surface.

The method may further include rotating the peening device such that the flexible line extends transversely relative to a major axis of the spindle or rotatable member, and such that the peening element rotates at an angular velocity relative to the major axis to operatively peen the surface. The surface may be operatively peened as result of kinetic energy of the peening element when it comes into contact with the surface, or impacts or engages the surface. Optionally, the method (400) may include implementing the flexible line as a single strand extending from the rotatable member, or implementing one or more single strands that extend radially from the rotatable member in use. The method (400) may also include providing one or more peening elements at or near an end of the flexible line (or lines), or at or near an end of the single strand (or strands).

The foregoing description has been presented for the purpose of illustration; it is not intended to be exhaustive or to limit the invention to the precise forms disclosed. Persons skilled in the relevant art can appreciate that many modifications and variations are possible in light of the above disclosure. The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Finally, throughout the specification and accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

1. A peening device comprising:
a rotatable member rotatable about an axis;
a flexible line that extends from the rotatable member; and
a peening element that is provided on the flexible line, wherein the flexible line and peening element are operatively rotatable about the axis to peen a surface in use.

2. The peening device as claimed in claim 1, wherein the rotatable member is a spindle.

3. The peening device as claimed in claim 1 or 2, wherein the peening element is operatively located at a part of the flexible line furthest away from the rotatable member.

4. The peening device as claimed in claim 1, wherein the flexible line has a plurality of peening elements provided thereon.

5. The peening device as claimed in claim 1, wherein the flexible line is arranged in a loop with one or more peening elements through the loop.

6. The peening device as claimed in claim 1, wherein the flexible line is a single strand extending from the rotatable member, with one or more peening elements provided on the single strand.

7. The peening device as claimed in claim 2, wherein the spindle includes a proximal end and a distal end, and wherein the proximal end is configured to be attached to a rotary drive for rotating the spindle in use with the flexible line extending from the distal end of the spindle.

8. The peening device as claimed in claim 1, wherein the rotatable member is elongate and extends along a major axis, and wherein the rotatable member is operatively rotatable about its major axis so as to cause the flexible line to extend and the peening element to move in a generally circular path around the major axis of the rotatable member in use.

9. The peening device as claimed in claim 1, wherein the peening element includes an aperture therethrough and the flexible line is threaded through the aperture.

10. The peening device as claimed in claim 1, wherein the peening element is formed from a tough material selected from the group consisting of: tungsten, titanium, steel, glass, composite materials and ceramics.

11. A method of peening a surface, the method comprising:
providing a peening device, the peening device having a rotatable member with a flexible line that extends from the rotatable member and a peening element that is provided on the flexible line; and
rotating the peening device such that when the peening element operatively comes into contact with the surface, the surface is peened.

12. The method of peening a surface as claimed in claim 11, wherein the method includes rotating the peening device such that the flexible line extends transversely relative to a major axis of the rotatable member, and such that the peening element rotates at an angular velocity relative to the major axis to peen the surface.

13. The method of peening a surface as claimed in claim 12, wherein the flexible line performs a whipping action when the rotatable member is rotated about its major axis in use.

14. The method of peening a surface as claimed in claim 11, wherein rotation of the rotatable member causes the flexible line to extend as result of a centrifugal force associated with the peening element on the flexible line, and wherein the surface is operatively peened as result of kinetic energy of the peening element when it comes into contact with the surface.

15. The method of peening a surface as claimed in claim 11, wherein the method includes implementing the flexible line in a loop with one or more peening elements through the loop.

16. The method of peening a surface as claimed in claim 11, wherein the method includes implementing the flexible line as a single strand extending from the rotatable member, with one or more peening elements provided on the single strand.
